(19) United States
(12) Patent Application Publication
(10) Pub. No.: US 2009/0152872 A1
(43) Pub. Date: Jun. 18, 2009

(54) SYSTEM FOR COLLECTING ENERGY FROM THE ROTATION OF THE EARTH

(76) Inventor: Fradique Lee Duarte, Colonia Mariscal (GT)

Correspondence Address: BROOKS KUSHMAN P.C., 1000 TOWN CENTER, TWENTY-SECOND FLOOR, SOUTHFIELD, MI, 48075, US

(21) Appl. No.: 12/391,219

(22) Filed: Feb. 23, 2009

Related U.S. Application Data
(63) Continuation-in-part of application No. PCT/IB2007/052469, filed on Mar. 28, 2007.

(30) Foreign Application Priority Data
Aug. 22, 2006 (GT) PI-20060382

(51) Int. Cl. F03B 13/10; B65D 90/02

(52) U.S. Cl. 290/54; 220/566

(57) ABSTRACT

The invention relates to the formation of cyclones to produce electrical power that is environmentally-friendly, clean, inexhaustible and abundant to the extent that current consumption is insignificant. The invention makes use of the acceleration imparted by the Earth to the fluid that passes transversely through the latitudes, directing same to the closest pole. The invention comprises a duct which can be straight, in the form of a doughnut (toroid) or have any geometrical shape, when level in one of the hemispheres, the fluid is directed towards the pole and the Equator in the case of the straight duct and rotated in the direction of rotation of the Earth in the case of the doughnut. The initial movement is forced and subsequently accelerated and sustained by the rotational movement of the Earth. As a result of said movement, the fluid drives the turbines which produce electricity.

### CROSS-REFERENCE TO RELATED APPLICATIONS

This application is a continuation-in-part of PCT application Serial No. PCT/IB2007/052469 filed Mar. 28, 2007, which claims priority to Guatemala application Serial No. PI-20060382 filed Aug. 22, 2006.

### BACKGROUND

1. Field

One or more embodiments generally relate to a method and systems for collecting energy that is created by the rotation of the earth.

2. Background Art

Back in 1974, I was concerned with the idea of achieving “the energetic use of the rotation of the earth”, so I studied by myself the Coriolis Effect, having no conclusion at that time. During 1982 to 1985 I was led to think on writing a book regarding the matter that North American and Canadian people are traveling on Earth at less velocity than Central Americans, due to the rotation of the earth. The book was going to give an explanation about their behavior, health and development just because people are traveling in different velocities. In 2001, I was aware that the movements of the ocean moves contrary to the rotation of the earth. I tried to search in scientific literature, but do not found scientific explanation regarding this phenomenon, and while going more deeply on this matter and giving a explanation to high and low tides and the moon's position, I established that there is a force or phenomenon, that up to day has not been considered by the science: its effect, which is a gravitational attraction caused by the gravity center of the Earth-Moon System.

Analyzing the translation period of the moon, almost 28 day; and the rotational period of Earth's rotation which is a revolution of 24 hours, we can see that this leave to the Earth-Moon gravity center a relative rotational movement in opposite direction to Earth's rotation; this clearly establishes that if there is a plummet in any place of the Earth. Such plummet is mainly attracted by Earth's gravity center and the gravity center of the Earth-Moon System, this Earth-Moon System gravity center has a movement of relative rotation near to 1,250 km/hr. This clearly establishes, that the plummet varies in a circular way, during 24 hours.

I discovered this phenomenon, which I called “Fradiquelees” (name of one of my children). When relating this with the Coriolis Effect, I noticed, that both effects, work opposite to Earth's rotational movement (maintaining the balance) then I wonder what's happening . . . when overcoming this two effects, I discovered that, practically, this is the principle of cyclones formation.

Cyclones are formed when overcoming the Coriolis and “Fradiquelees” effects, air is heated and start to elevate, instead of obeying the normal movement, air starts to spin in an opposite way, because its rotational vector changes direction. An explanation is given by the principle of the “Right Hand Rule”, which is used in Mechanical Engineering and is applied to vectors.

Studying the existing theories about cyclones formation, I just found explanations that in my opinion do not have enough scientific support. Therefore, I look for an explanation, which I describe above and is supported by the “Right-Hand” principle, known in the Mechanic Engineering. It could be said that these are the genes of the cyclones formation.

### SUMMARY OF THE INVENTION

In at least one embodiment a method for creating a cyclone for producing energy is provided.

In another embodiment, a toroid system is provided for collecting energy from the rotation of the Earth.

In yet another embodiment, a transoceanic transportation system is provided for collecting energy from the rotation of the Earth and using the energy to transport goods and submarines.

### BRIEF DESCRIPTION OF THE DRAWINGS

FIG. 1 is a plan view of a diagram of the Earth;

FIG. 2 is a partial plan view of a diagram of the Earth, illustrated with a toroid system positioned in the northern hemisphere;

FIG. 3 is a diagram of a spinning disc having an internal sphere;

FIG. 4 is another diagram of a spinning disc having an internal sphere;

FIG. 5 is front view of a diagram of the Earth;

FIG. 6 is another front view of a diagram of the Earth, illustrated with a plurality of lateral bands;

FIG. 7 is another front view of a diagram of the Earth, illustrated with a plurality of lateral bands;

FIG. 8 is another front view of a diagram of the Earth, illustrated with a plurality of lateral bands;

FIG. 9 is another plan view of a diagram of the earth, illustrated with the toroid system positioned in the northern hemisphere;

FIG. 10 is an enlarged section view of the toroid system of FIG. 9;

FIG. 11 is another enlarged section view of the toroid system of FIG. 9, illustrated with a series of motors and generators in accordance to one embodiment of the present invention;

FIG. 12 is another front view of a diagram of the earth;

FIG. 13 is a front view of a diagram of a Earth-Moon System;

FIG. 14 is another plan view of a diagram of the Earth;

FIG. 15 is a plan view of the Earth, illustrated with a series of toroid systems;

FIG. 16 is another plan view of a diagram of the Earth, illustrated with sectioned into a plurality of quadrants;

FIG. 17 is another plan view of the toroid system of FIG. 9;

FIG. 18 is a front section view of the toroid system of FIG. 11;

FIG. 19 is a plan view of a transoceanic transport system in accordance with another embodiment of the present invention;

FIG. 20 is a plan view of another embodiment of the transoceanic transport system of FIG. 19;

FIG. 21 is a plan view of yet another embodiment of the transoceanic transport system of FIG. 19;

FIG. 22 is a front view of the transoceanic transport system of FIG. 21; and

FIG. 23 is a front section view of the toroid system of FIG. 9, illustrated with a toroid retention system.

### DETAILED DESCRIPTION OF THE EMBODIMENTS OF THE PRESENT INVENTION

In general, cyclones and tornadoes are formed when the winds are conditioned by the temperature changes caused by the Sun, which comes to dominate the force of the gravitational attraction of the Earth Center and the gravitational center of an Earth-Moon System 30 and this provokes that the winds circulates in opposite way to the clockwise. With rotational movement, that is why cyclones are so quick. Rotation goes counterclockwise.

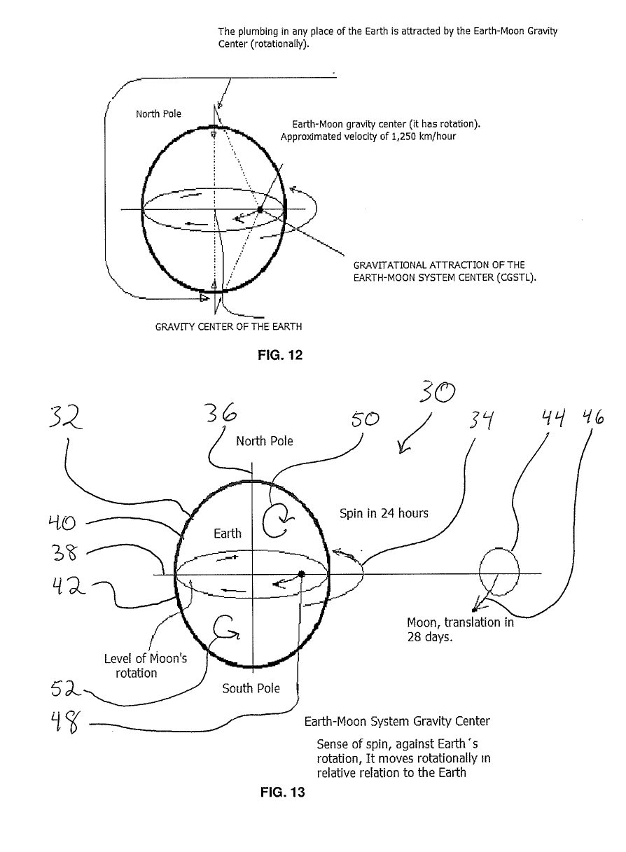

Referring to FIGS. 12-13, the Earth-Moon system 30 is shown. The Earth-Moon system 30 includes the Earth 32 which rotates in a generally counter clockwise direction 34 about a central axis 36. The Earth 32 is bisected at the equator 18 into a northern hemisphere 40 and a southern hemisphere 42. The moon 44 revolves around the Earth 32 in a generally clockwise orbit 46. The gravitational attraction of the Fradiquelees Effect provokes that one plummet has a spin movement in 24 hours. The attraction 48 results in a clockwise current 50 in the surface bodies and fluids of the northern hemisphere 40 and a counterclockwise current 52 in the fluid of the southern hemisphere 42.

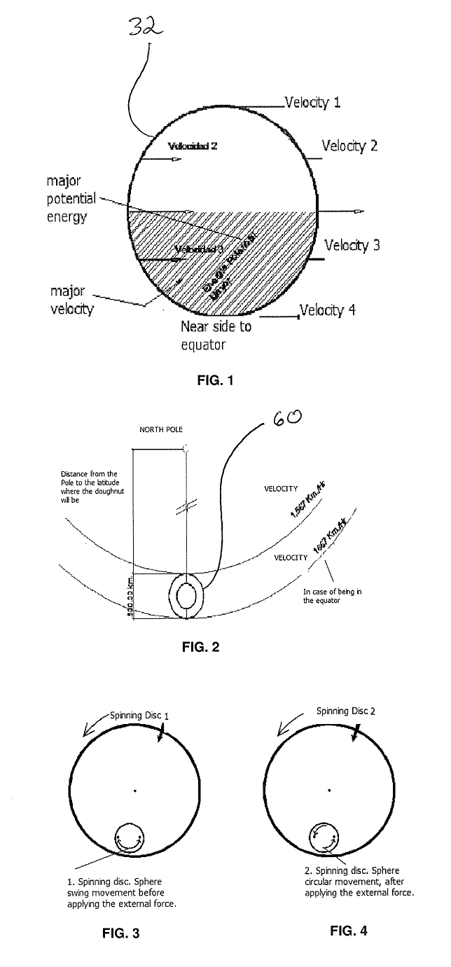

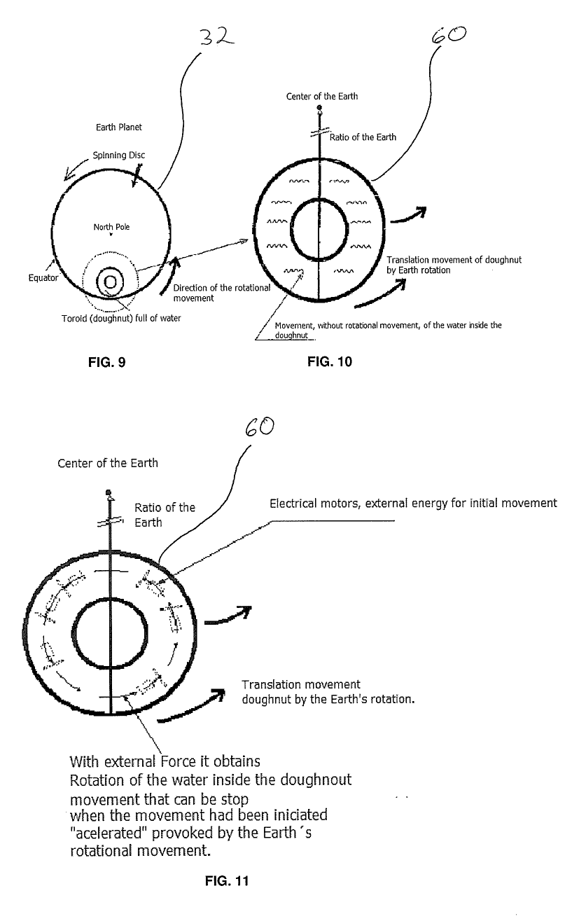

With reference to FIGS. 1-13, any fluid moving away from the equator 38 toward the North Pole or South Pole gains relative speed (air in the latitude near to the equator 38 has no relative speed in that latitude, but when being transferred to the following latitude, it accelerates due to the difference in velocity between both latitudes).

If we provoke that this transference to be made with a spin in a circular way, the system maintains itself because this fluid is accelerated by Earth's rotation 34. If we place a toroid system 60 in any place of the planet, this has more potential energy in its “down” medium circle, than the energy of its “up” medium circle, in the northern hemisphere 40 it is the opposite concerning the southern hemisphere 42. This means that half of the circumference near to equator 38 has more energy than the other half far from it, due to different velocities of the latitudes.

FIG. 8 illustrates the Earth 32 with a series of lateral bands 54 equally spaced every 250 km from the equator 38. Upper band 36 represents a location 1,000 km from the equator 38. The tangential velocity on the surface of the Earth 32, is proportional to the angular velocity and radius towards the Earth's central axis 36. The Earth 32 rotates at a constant angular velocity. Since the radius of the Earth 32 is greatest at the equator 38, the tangential velocity at the equator (approximately 1,666 km/hr) is greater than the tangential velocity at the upper band 36 (approximately 1,466 km/hr).

If we calculate the tangential velocity at the equator 38, and divide this value by the 24 hours of the rotation duration (circumference of equator/24 hours it is 463 m/s. In the poles, the velocity is zero, which means that if we go from the equator 38 to the poles, the velocity is varying from kilometer to kilometer at a velocity of 0.04722 m/s per km. If we provoke a velocity to transfer air from latitude towards another latitude, with a constant velocity of 10 m/s, we would have an rotational acceleration of 0.000472 m/sec2 (not about acceleration of the centrifugal force).

With this acceleration, an increase in the tangential velocity is formed, which again provokes acceleration and so, the tangential velocity and acceleration increase every time before the system stabilizes itself. And maintains its movements indefinitely, giving more energy if it goes in the counterclockwise sense, it gives less energy when going in the clockwise direction.

Referring back to FIG. 1-2, we can notice that there is an imbalance (stationary) of potential energy, which if the stationary energy brakes, it could establish a counter clockwise because the movement to the clockwise direction that initially accelerates until it stabilizes.

The Fradiquelees effect imparts a gravitational attraction caused by the gravity center 48 of the Earth-Moon System 30. It acts on all bodies of the Earth 32, in opposition to the Earth's rotation 34, thereby maintaining equilibrium.

If air is pushed with a constant velocity from latitude 10° toward north toward the latitude 30° north, in a pipe this air have, when exiting the pipe, a major velocity than the constant velocity with which it was pushed; this velocity was gained due that the rotation velocity in the 10° latitude is greater than latitude 30° north (relative velocity); this leaves a differential velocity equal to the difference of the 10° latitude velocity with relation to the 30° latitude velocity, (without taking into account the friction caused in the pipes).

If we circulate a fluid within the toroid system 60 having an overall diameter of 200 km and a duct 64 diameter of 6 m, giving the fluid a velocity of 5 m/s; after having this velocity, it achieves an acceleration caused by the fluid own velocity when it pass through a latitude near the equator latitude moving to a latitude near the poles, which is a velocity of 0.04722 m/s per each km of distance between latitudes, this acceleration would be equal to 0.0002361 m/s2. This acceleration is caused by the initial acceleration applied, will give a new major velocity than the 5 m/s, achieving with this acceleration to obtain a variable velocity, which repeats again and again, obtaining variable velocity and a variable acceleration prior to the stabilization of the system.

A contribution to the fluid movement in a duct 64 of the toroid system 60 is given by the left half of the doughnut, it works as a pump casing, that has a greater tangential velocity that the fluid velocity flowing in the duct. This means that whatever gets into the casing, goes out at the end, with a equivalent velocity to the corresponding latitude velocity of that extreme.

Referring to FIGS. 3-4, the theory for collecting energy from the rotation of the Earth is explained. If over a spinning disc in a transversal axis, we place a little ring which is stuck to the internal circumference of the disc, over it is a sphere; the sphere starts with a swinging movement having no rotation; if then we apply a circular push to the sphere, this spins and continue spinning while the disc spins. And maintains its movements indefinitely, giving more energy if it goes in the counterclockwise sense, but gives less energy when going in a clockwise direction.

With reference to FIGS. 12-13, there are primarily two effects or forces in nature that oppose the rotational force of the Earth 32. Although the elements moving in the Earth's surface fluid are not moving in the direction of the rotational force; these effects are the “Coriolis” and the “Gravitational” of the Earth-Moon System 30 (effect that I name Fradiquelees).

The Coriolis Effect is an inertial effect, where the elements oppose to change its current status. Gravitational or Fradiquelees Effect: The gravity center of the Earth-Moon System 30 is always spinning in the opposite direction to the Earth's rotation 34, by approximately a velocity of one thousand two hundred fifty kilometers per hour, which causes the surface fluid be attracted in a opposite direction of the Earth's rotation 34. This attracts all bodies' elements in Earth 32. They have the tendency to move in the clockwise direction, but does not mean they are all moving. Also the Coriolis effect (it is a reaction opposing a movement, it is not an attraction), has the tendency to move or spin in the same direction (sense) with Fradiquelees effect.

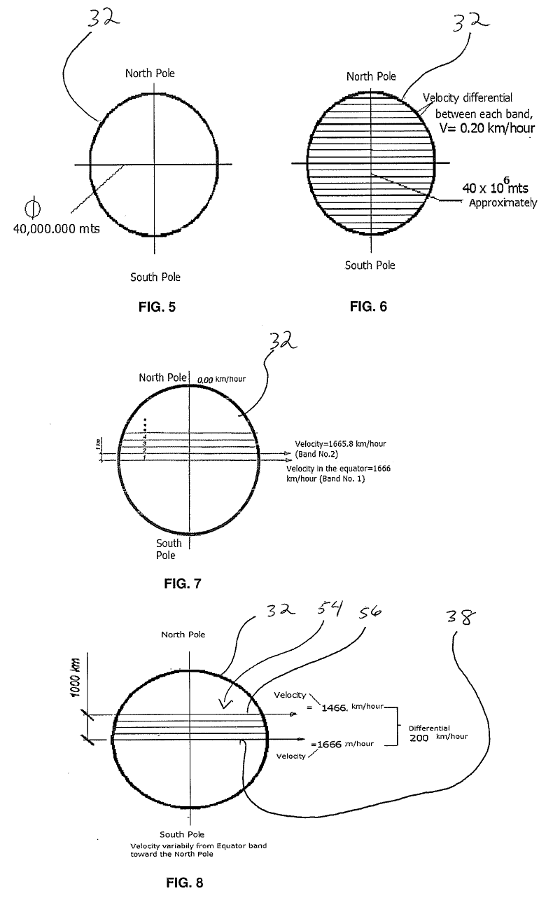

Referring to FIGS. 5-7, if we assume that the Earth 32 is a sphere and is approximately 40,000 km in diameter and supposing that the Earth 32 is a sphere as such, even though in the reality the circumference going through the poles is smaller than the circumference of the equator 38; calculating the velocity with which the parallels will vary, taking them as widely separated bands 1 kilometer from equator to the poles, it will give a velocity differential of approximately 0.20 km/hr per kilometer.

Referring to FIG. 8, the equator 38 has a tangential velocity of 1,666 km/hr. The upper band 56, which is approximately 1,000 km from equator, has a tangential velocity of 1,466 km/hr. Thus the velocity difference between the two bands is approximately 200 km/hr.

If we manage to do that one thing (gasses, liquids, solids or a combination of these) travel from one band to another, this band has the capacity, without swooning, of transporting whatever it is given, it takes one “thing” to the same velocity, whether it is light or heavy, (because of the magnitude of Earth forces). When we walk from one band to another, the surrounding air and we are changing velocity in direction, in which the Earth's bands 54 are going.

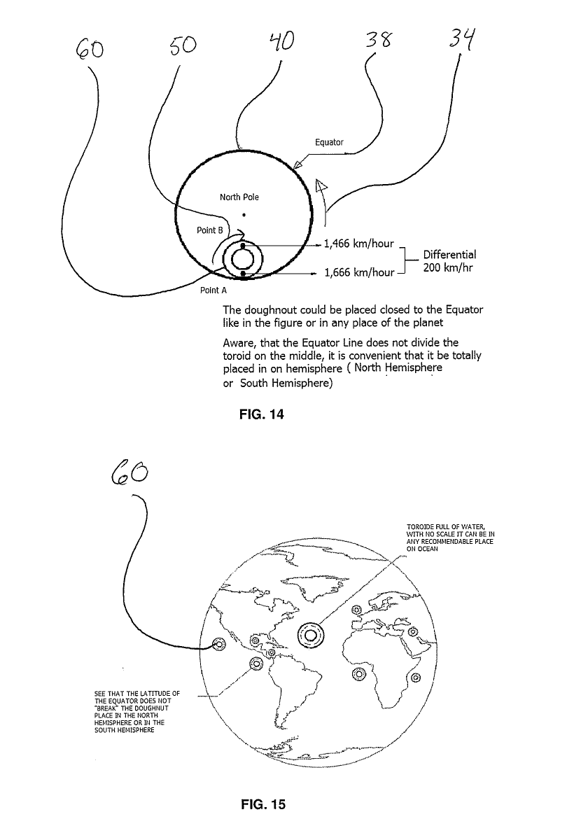

FIG. 14 illustrates a top view of the Earth 32. The toroid system 60 having a circular tubular structure is filled with fluid and placed within the ocean in the northern hemisphere 40. The Earth 32 rotates in a counter clockwise direction 34.

If an external force is applied within the toroid 60 that is sufficient to overcome the natural swaying movement of the current, such that the current flows in the same direction as the Earth rotation 34 (i.e. to force the clockwise current 50 to flow in a counter clockwise direction) then the movement of the water will produce energy from the rotation of the Earth 32. Once the fluid achieves sufficient speed and momentum the external force will stop and the fluid will maintain its direction (sense), due to the fluid being accelerated by the rotation of the Earth 32. The speed of the circulating fluid will now be greater when powered by the rotation of the Earth 32.

Referring to FIGS. 14-15, the toroid system 60 is located within the northern hemisphere 40 and the internally circulating fluid is forced by an external force, to flow in a counter clockwise direction then we have overcome the natural forces opposing the Earth's rotation 34 and have reached to be in accordance with the Earth's rotation 34 thereby generating a great acceleration and a greater velocity than the initial one that was used to provoke the movement. The toroid system 60 is positioned near the equator 38. However, crossing the equator 38 will disturb the flow.

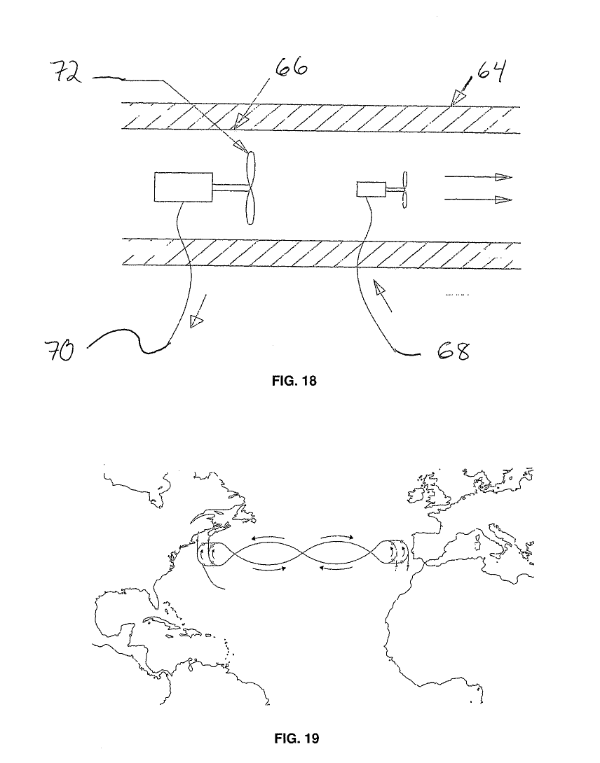

Referring to FIGS. 17-18, the toroid system 60 comprises a hollow circular duct 64. The external wall of the duct 64 protects internal floating material 66 which provides buoyancy to the toroid system 60. The inner wall of the duct 64 has a smooth low friction surface, such that the circulating fluid may flow.

The external force is provided by a series of motors 68 that are mounted within the duct 64. The motors 68 each have a propeller fixed to their output shaft and are used to impart a force on the fluid circulating within the duct 64 in order to reverse the direction and to give acceleration to the direction (sense) of the fluid, which can be clockwise and inverse sense, obtaining more energy in the counter clockwise direction (sense). The motors 68 receive external electric power from a battery or series of batteries (not shown).

A series of generators 70 having intelligent blades 72 are positioned with its blades 72 in a convenient form, for the start and when the system is already stabilized. The generators 70 will obtain electric energy, which will be translated to transformers for distribution.

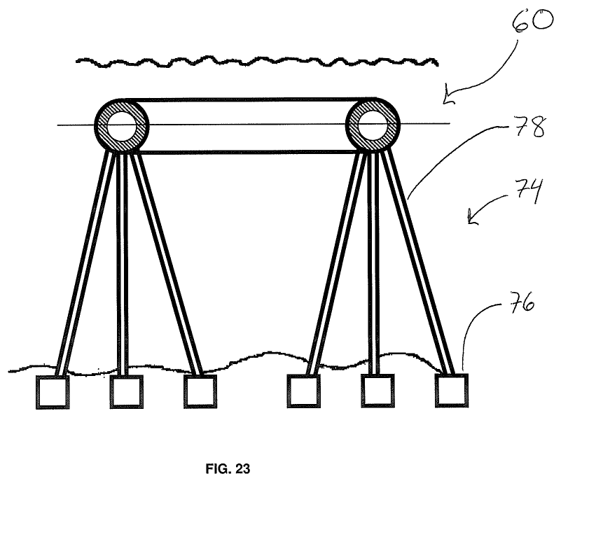

FIG. 23 illustrates a toroid retention system 74. The retention system 74 is used to maintain a position of the toroid system 60 relative to the ocean floor 90, while allowing some flexibility regarding the present depth of the toroid system 60. A series of cables 78 attach the toroid 60 to anchors 76 that are embedded in the ocean floor 90. The cables 78 may be braided metal strand for providing strength and flexibility.

Alternate embodiments of the toroid 60 envision other geometrical shapes such as a figure eight, ellipse or spiral. If exit any figure geometrical figures, in which the principle be the same, where a close circuit can also occur. During the tests we performed, we found out that the toroid configuration was more efficient.

With reference to FIG. 17, the work pressure in the duct 64 is low, because it is a circular system and the pressure can be designed evenly distribution in all system, with which we can attain to works with a convenient differential pressure, being the toroid system 60 is immersed in a convenient level of the sea.

For a toroid system 60 having a 310 mile (˜500 km) diameter with a tube diameter of 30 ft (˜10 m) the necessary power to attain the initial movement of 1.2 mph (2 km/hr), ignoring any variation in fluid height, for a friction of a tube friction is approximately: in a 30″ diameter tube, has a water column 0.06 ft per 100 ft of tube. The necessary potency is 45 Mega Watts (60,000 HP), as shown below:

0.06*30*(1.82)2=0.004568 ft/100 ft

GPM=((X*d2)/4)*33.3 mts/min*1000 lt*GI=691,900 GPM

HP=691,900 GPM*0.004568 ft/100 ft*0.5*106 mts*X*3.3 ft/mt

HP=59,103 HP

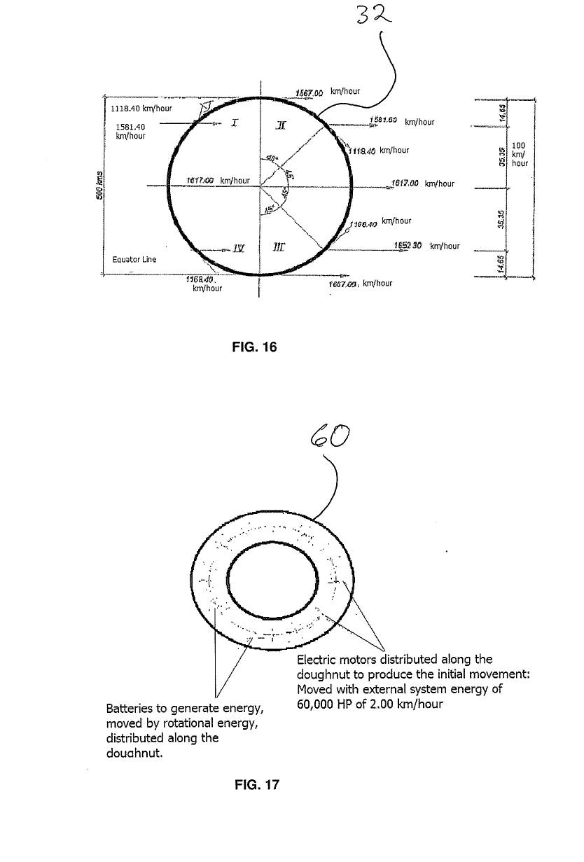

Referring to FIG. 16, for analyzing the potential kinetic energy of fluid's total volume inside the doughnut, we have: In quadrant I and II the forces of the fluid direction are opposite to quadrants III and IV: but quadrants III and IV are greater since they are closer to equator (where velocity is greater).

Analyzing the energy in the quadrants, we have:

E_{I}=½*m_{I}*V_{I}²

E_{II}=½*m_{II}*V_{II}²

E_{III}=½*m_{III}*V_{III}²

E_{IV}=½*m_{IV}*V_{IV}²

m_{I}=m_{II}*m_{III}*m_{IV}=¼*M Total of the toroid 60

VI, VII, VIII, VIV=Average velocities to be considered.

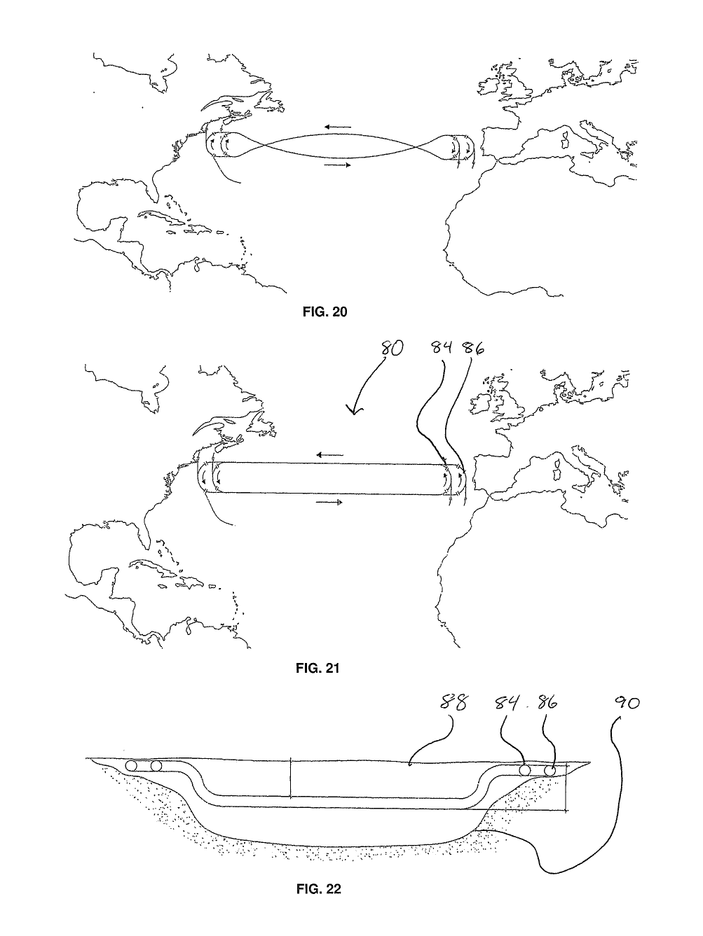

With reference to FIGS. 21-22, a transoceanic transportation system 80 is provided whereby goods or submarine capsules (not shown) are transported by the energy generated by the Earth's rotation 34. Similar to the toroid system 60, a series of motors (not shown) are used to accelerate the natural flow of fluid circulating within the transport system 80, and generators (not shown) may be used to collect energy from the circulating fluid. The generators will send directly electrical energy to transformers of distribution, for use of the transportation system, or to sell the energy for human consumption.

Goods and submarines enter one end of the transport system 80 at the load/unload area 84, and exit at a port at the opposite end of the system 80.

Submarines traveling within the transport system 80 may include means for self propulsion or may be carried by the circulating fluid. The idea is to take advantage of the submarine principle; the weight of the load would be held by the water to flow and its transportation by the water movement; this moved by the Earth's rotation 34. To start the Submarine-capsule journey, will be through two or more entries to the system; the submarine capsule floats with the load, when throwing off “almost all” clean water ballast. When the submarine loads with ballast water, it submerges, and remains at a set depth as it travels. The transport system 80 includes floodgates 86 at opposing ends of the system 80 to regulate the amount of fluid within the system 80.

The submarine-capsule can be conditioned to transport containers and passengers will count with oxygen equipment, as submarines actually work. The limit of velocity is subject to the capacity of maneuver.

Referring to FIGS. 19-21, alternate embodiments of the transoceanic transport system are provided whereby the overall shape of the system crosses independently, one tube over the other.

Alternative embodiments of the transoceanic transport system 80 are envisioned where other types of fluid, such as oil or “sweet” water circulate within the system 80 to be transported from one port to another, gate to gate, (i.e. transport sweet water from the end of the Mississippi River to the African desert).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for collecting energy from the rotation of the earth, the system being submerged in the ocean and subjected to natural forces to encourage fluid to circulate within, the system comprising:
a tubular duct for enclosing a fluid in a closed circuit, the fluid naturally circulating in a first direction therein;
a series of motors mounted within the duct for imparting a force on the fluid to reverse the fluid to flow in a second direction, such that the fluid flowing in the second direction is accelerated by a rotation of the earth; and
a series of generators mounted within the duct for collecting energy from the circulating fluid.

2. The system according to claim 1, further comprising a retention system for securement at a location within an ocean, the retention system having a plurality of cables extending from the duct to anchor the duct to an ocean floor.

3. The system according to claim 1, wherein the duct extends from a first port of a first continent to a second port of a second continent.

4. The system according to claim 3, wherein the duct is sized for transporting goods between the first continent and the second continent.

5. A method for collecting energy from the rotation of the earth, the method comprising:
locating a tubular duct for enclosing a circulating fluid within an ocean, whereby the fluid naturally circulates in a first direction therein;
imparting a force on the circulating fluid for reversing the first direction of fluid flow; and
collecting energy from the circulating fluid by energizing a series of generators within the duct.

6. A system for exploiting energy derived from the rotation of the Earth, the system comprising:
a doughnut shaped pipeline (torus or toroidal), it may be the pipeline enlarged in some parts, or any geometric figure or not, the pipeline forming a closed circuit at any spot of terrestrial surface (in water and/or on Earth) preferably in level, following the curvature of Earth body to avoid frictional losses, in the water case, it may be an open circuit, if the fluid to flow is water of the contour; considering the strength required by the fluid, in order to go out from the pipeline and to direct it to the same way to the movement of the water in that depth location, it may be submerged into the ocean to certain depth (not in the sea bed) to maintain its level or almost it, reaching, with the previous, to provoke inside the pipeline, a constant fluently movement, to use energy from the Earth's rotation or satellite, or in any celestial body in space, because of the defeat of the Coriolis Effect and the Gravitational Effect, the use of any figure type, which also, forms a close circuit; like as in case of an eight or a spiral figure, which closes or not, to translate any fluid, can be: liquid, solid, gaseous, or any combination, the exploitation of any fluid, which can be forced by bombs or any other way (mechanic, hydraulic, electric) and particularly moved by the energy of a rotation force of Earth or any celestial body on space; and wherein the system may used to carry submarine capsules, submerged on a fluid where these capsules may flow to translate, the capsules may have or not self-propulsion.

7. The system for exploiting energy derived from the rotation of the Earth according to claim 6, wherein the doughnut shaped pipeline further comprises: energy that is obtained by the doughnut or toroid pipeline, it can be enlarged in any of its parts or from a circular pipeline or any geometric figure or not, with open or close circuit, if it is on the same environment with the fluid to flow, a previous concept depends on the theory: that gravitational center of Earth-Moon System, its always spinning against in of the Earth's rotational movements, wherefore the water is spinning in opposite way to the Earth's rotational movements, this force attracts rotationally to all bodies, that are, on terrestrial surface (water or ground), causing the rotation of some of these bodies which are moving to the same direction as Coriolis and Gravitational Effects, both, to the same direction, when the movements on the terrestrial surface are normal; whereby, if we provoke, with an external force, that the fluid moves in opposite direction to Coriolis and Gravitational Effects of Earth-Moon's gravitational center; we obtain a major movement in the direction to rotational force of a planet on celestial body.

8. The system for exploiting energy derived from the rotation of the Earth according to claim 6, wherein an exterior force provokes the flow of the fluid on the pipeline, doughnut or toroid, the pipeline may be enlarged in some parts; or any geometric figure or not; the passing of a band of the Earth or from a celestial body to another band (speed differential by the distance to Equator), this band has the capacity without discouraged to carry whatever it is collocated to be transported, with the same velocity, even if it is light or heavy, (because of the magnitude of the strengths of the Earth's rotational force).

9. The system for exploiting energy derived from the rotation of the Earth according to claim 6, wherein the pipeline is situated between the equatorial parallel and the north parallel, at the sea level, following the curvature of the celestial body, or submerged into a determined height (altitude), and filled with water, the water will be in uniform movement according Earth's rotation, but when an external force is applied (meaning external to the terrestrial movement), the external force produces movement to the restrained water inside the pipeline, opposite the Corioles Effect force, whereby the external force is greater than the Coriolis Effect and Gravitational Effect forces to change the movement of the water to travel counter clockwise, and conversely if the system is situated between the equatorial parallel and the South parallel, the system placed in the sea, or submerged to certain height; the movement will be clockwise.

10. The system for exploiting energy derived from the rotation of the Earth according to claim 9, wherein applying an external force, to the fluid results in the opposite way of the rotation; the exploitation of energy will be minor than if it is spinning with the same direction to the rotation way of the celestial body.

11. The system for exploiting energy derived from the rotation of the Earth according to claim 9, wherein the duct may be any geometric figure or not, may be applicable wherever it has a closed circuit; as in the closed spiral case, or the eight case or in an open system with correct mechanism that does not allows the fluid lose their fluidity; having the open or semi-open mechanism in a controlled system, to let enter the same amount of fluid that goes out at the other extreme, keeping the movement of the fluid into the pipeline.

12. The system for exploiting energy derived from the rotation of the Earth according to claim 9, wherein when using the cyclones principle to defeat the Coriolis and Gravitational Effects, Fradiquelees (Earth-Moon System), can translate submarines capsules to transport such submarine capsules exploiting fluid environment.
